(19) United States
(12) Patent Application Publication
(10) Pub. No.: US 2002/0135250 A1
(43) Pub. Date: Sep. 26, 2002

(54) Differential voltage battery DC inverter

(75) Inventor: Herbert Pardo, Weston, FL (US)

Correspondence Address: SCOTT L. LAMPERT, ESQ., LAW PRACTICE OF SCOTT L. LAMPERT, P.A., P.O. BOX 813449, HOLLYWOOD, FL, 33081-3449, US

(73) Assignee: BETTER POWER SUPPLY, INC.

(21) Appl. No.: 09/785,372

(22) Filed: Feb. 16, 2001

(51) Int. Cl. H02K 39/00

(52) U.S. Cl. 310/111

(57) ABSTRACT

A DC to AC inverter comprising a battery structured to provide a plurality of DC voltages and a switching system comprising a mechanical rotation system having a stator with a plurality of spaced-apart, conductive contacts, each electrically interconnected to one of the battery DC voltages and arranged so that, as the stator is circumvented in a single direction, the DC voltage of successive contacts increase in steps from 0 volts to the uppermost DC voltage and then decrease in steps to the lowermost voltage, and then increase in steps back to 0 volts, a rotor positioned within the stator and structured to revolve within the stator so that its conductive brushes electrically engage each contact during one revolution of the rotor, causing the brushes to pick up each contact's DC voltage as the brushes electrically engage each contact, and a motor structured to rotate the rotor. As the rotor revolves within the stator and the brushes electrically engage the contacts during each cycle, the DC voltage present at the brushes cycles from 0 volts to each positive DC voltage between 0 volts and the uppermost DC voltage, in increasing voltage steps, to each DC voltage between the uppermost DC voltage and the lowermost DC voltage, in decreasing voltage steps, and then to each DC voltage between the lowermost DC voltage and 0 volts, in increasing voltage steps, producing a substantially sine wave shaped voltage waveform.

### BACKGROUND OF THE INVENTION

1. Field of the Invention

The present invention relates to power supply devices and, more particularly, to an inverter capable of efficiently producing AC voltage from battery DC voltages.

2. Description of the Related Art

With the proliferation of computers and other electronic devices, the need for backup power sources has increased greatly over the past several years. Most businesses and many homes now employ battery backups with computer systems to prevent loss of data due to power interruptions. In addition, the need for mobile power sources has also increased as the use of electronic devices on boats, airplanes and other vehicles has grown. As discussed below, applicant has discovered several deficiencies with existing backup and mobile power sources currently available today.

Uninterrupted Power Supplies, or UPS, are the most commonly used backup power sources available today. UPS systems consist of batteries and electronic circuitry to convert the batteries'DC output voltage to an AC voltage, which is then supplied to the computer or other electronic device to replace the unavailable line AC voltage. The batteries are charged by rectifier circuits when the line AC voltage is present.

The electronic circuitry, which converts the batteries DC voltage to AC voltage, is commonly referred to as an inverter. Referring now to FIG. 1, traditional electronic inverters essentially take the DC voltage from the battery and create a square wave. However, the AC voltage used by the computers and other electronic devices consists of a sine wave. Thus, the remaining portion of the square wave is dissipated as heat, resulting in an approximate thirty percent loss of amperage during the DC to AC conversion in the UPS. In other words, if 70 amps are required to run a particular electronic device, the UPS battery must produce approximately 100 amps.

As a result of this loss of efficiency, UPS systems, typically, only operate for short periods of time. To operate for longer periods, larger batteries would be required, making the UPS larger and more expensive. Moreover, as the UPS batteries increase in size, the amount of heat being dissipated by the inverters increase, necessitating fans, water coolers or other cooling systems to cool the system, thereby further increasing the size and cost of the system, as well as the drain on the batteries.

Consequently, UPS systems are usually only intended as a short-term backup power source, which only supplies power during periods of normal AC power interruption, to give the user sufficient time to save any computer applications in use and shut down the equipment. Line AC power, when available, is still intended to be the primary power source for the electronic equipment, as well as being necessary to recharge the UPS batteries.

In many geographical locations, especially in countries in Central and South America, it is not uncommon to have frequent power outages or even no AC power for most of the day. Such long-term loss of AC power essentially renders UPS systems, as well as the regular internal electronic device power supplies, useless, posing substantial problems for those individuals and businesses reliant on computers and other electronic devices.

Various other types of backup and mobile power sources have been developed over the years. However, virtually all of these prior art devices operate on the same principle as UPS systems, that is, DC voltage from batteries is converted to AC using electronic inverter circuitry. Thus, these other prior art devices include the same inefficiencies inherent in UPS systems.

Accordingly, the prior art backup and mobile power sources teach the use of electronic inverting circuitry to convert battery DC voltages to AC voltage usable by electronic devices. Applicant has discovered that the limitations of the prior art lie in their use of such inverting circuitry. Prior art electronic inverting circuitry is limited by the semiconductor technology that it uses, which is limited in its ability to conduct current and in the types of loads that it can handle. Applicant has discovered that an AC voltage can be produced from a differential voltage power source, without the substantial use of electronic inverting circuitry, resulting in virtually none of the loss of energy and efficiency and current and load limitations associated with conventional electronic inverting circuitry.

The prior art, as evidenced by its generally consistent approach in power supply designs, teaches away from such a power supply and fails to recognize the problem discovered by applicant. Consequently, there is no suggestion or motivation for one of ordinary skill in the art to modify any of the prior art devices in the manner disclosed by applicant's invention or in any other manner which might address this problem. Such lack of disclosure, suggestion or teaching in the prior art supports the conclusion that part of applicant's invention is the discovery of the problem that is, the need for a device which can produce an AC voltage from a DC power source without conventional electronic inverting circuitry.

Accordingly, there is a need for a device capable of producing AC voltage from a DC power source without the need for conventional electronic inverting circuitry, which reduces the inefficiencies, power loss and heat dissipation associated with the prior art devices, has no current or load limitations, can be used to power the load at all times, not just during AC power interruption, and extends the operating time during periods of AC power interruption and the useful life of the electronic equipment's components. The present invention is particularly suited to overcome those problems which remain in the art in a manner not previously known.

### SUMMARY OF THE INVENTION

The present invention is directed towards a new and improved DC to AC inverter comprising a battery structured to provide a plurality of DC voltages and a switching system structured to separately receive each of the DC voltages and to separately and sequentially output each of the DC voltages to generate at least one substantially sine wave shaped output voltage waveform. The switching system comprises a mechanical rotation system having a stator with a plurality of spaced-apart, conductive contacts on its inner surface, a rotor with a conductive brush extending out from its outer surface, and a motor structured to rotate the rotor. Each contact is electrically interconnected to one of the battery DC voltages. The contacts are arranged so that, as the inner surface of the stator is circumvented in a single direction, the DC voltage of successive contacts increase in steps from 0 volts to the uppermost DC voltage and then decrease in steps to the lowermost voltage, and then increase in steps back to 0 volts. The rotor is positioned within the stator and structured to revolve within the stator so that the brushes electrically engage each contact during one revolution of the rotor, causing the brushes to pick up each contact's DC voltage as the brush electrically engages each contact. As the rotor revolves within the stator and the brushes electrically engage the contacts during each cycle, the DC voltage present at the brushes cycles from 0 volts (neutral) to each positive DC voltage between 0 volts and the uppermost DC voltage, in increasing voltage steps, to each DC voltage between the uppermost DC voltage and the lowermost DC voltage, in decreasing voltage steps, and then to each DC voltage between the lowermost DC voltage and 0 volts, in increasing voltage steps. The brushes are electrically interconnected to a slip ring, structured to rotate with the rotor. A conductive output brush is positioned adjacent the slip ring, in electrical communication therewith, and is structured to pick up the slip ring voltage. As the rotor rotates and the brushes sequentially pick up the DC voltages from the contacts, in increasing and then decreasing steps, a substantially sine wave shaped voltage waveform is produced at the brushes and passed from the brushes to the slip ring and from the slip ring to the output brush. The resultant AC voltage may then be electrically interconnected to the desired electronic device.

It is an object of the present invention to provide a new and improved means for converting a DC voltage to AC voltage which has all the advantages of the prior art devices and none of the disadvantages.

It is another object of the present invention to provide a device for converting a DC voltage to AC voltage which reduces the inefficiencies, power loss and heat dissipation associated with existing prior art devices.

It is also an object of the present invention to provide such a device which does not use conventional electronic inverting circuitry.

It is a further object of the present invention to provide such a device which can power the load at all times, not just during times of AC power interruption.

It is yet a further object of the present invention to provide such a device which has no current and load limitations.

It is yet another object of the present invention to provide such a device which extends the operating time of the backup or mobile power source and the useful life of the electronic equipment's components.

These and other objects and advantages of the present invention will become more readily apparent in the description which follows.

### BRIEF DESCRIPTION OF THE DRAWINGS

For a fuller understanding of the nature of the present invention, reference should be had to the following detailed description, taken in connection with the accompanying drawings in which:

FIG. 1 is the output waveform of a conventional prior art inverter.

FIG. 2 is a block diagram the battery of the present invention showing the interconnected two volt cells to produce voltages ranging from positive ten volts to negative ten volts.

FIG. 3 is a cross sectional view of the stator and rotor showing a single segment of twenty-two contacts on the stator and a brush on the rotor.

FIG. 4 is a cross sectional view of the stator and rotor showing three twenty-two contact segments on the stator and a brush on the rotor electrically coupled to the slip ring.

FIG. 5 is a cross sectional view of the stator and rotor showing a single segment of twenty-two contacts on the stator and a brush on the rotor electrically interconnected to the slip ring.

FIG. 6 is a cross sectional view of the stator and rotor, in partial section, showing the electrical interconnection of the contacts to the diodes.

FIG. 7 is a block diagram showing the electrical interconnection of the battery to the contacts and the brush and the resultant waveform produced therefrom.

FIG. 8 is a schematic diagram of the battery, diode and transformer.

FIG. 9 is a cross sectional view of the stator and rotor showing three twenty-two contact segments on the stator and three brushes on the rotor electrically coupled to the slip ring.

FIG. 10 is a waveform produced by the embodiment of FIGS. 8 and 9.

FIG. 11 is a side plan view of the present invention showing a rotor with three pickup contacts and a stator with a plurality of brushes.

FIG. 12 is a cross sectional view of the stator and rotor showing a three phase embodiment, with three slip rings, each coupled to three pickup brushes.

FIG. 13 is a three phase waveform produced by the embodiment of FIG. 12.

FIG. 14 is a schematic diagram of the battery, diodes and transformers of a three phase embodiment.

FIG. 15 is a cross sectional view of the stator and rotor showing three twenty-two contact segments on the stator and nine brushes on the rotor, three electrically interconnected to each slip ring of a three phase embodiment

FIG. 16 is a three phase waveform produced by the embodiment of FIGS. 14 and 15.

FIG. 17 is a side plan view of a three phase embodiment showing a rotor with three pickup contacts, a stator with a plurality of brushes and three slip rings and output brushes.

FIG. 18 is a schematic diagram of the second preferred embodiment.

FIG. 19 is a schematic diagram of the second preferred embodiment showing the control oscillators, counters and dividers comprising the signal generator portion.

FIG. 20 is a schematic diagram of the second preferred embodiment showing the amplifiers.

Like reference numerals refer to like parts throughout the several views of the drawings.

### DETAILED DESCRIPTION OF THE PREFERRED EMBODIMENT

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

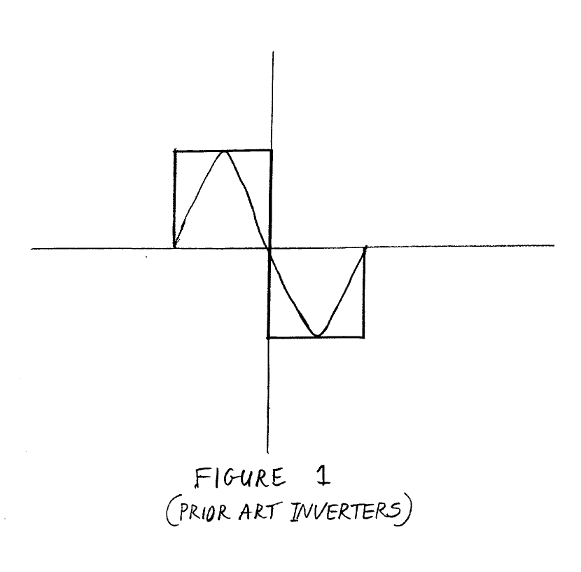

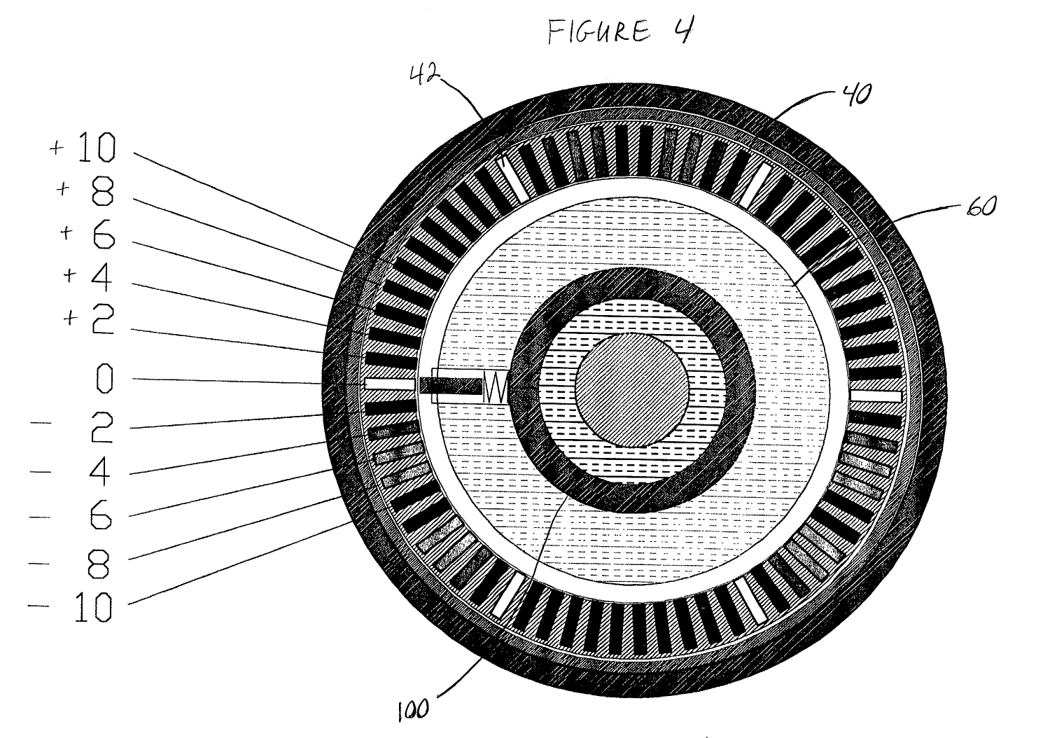

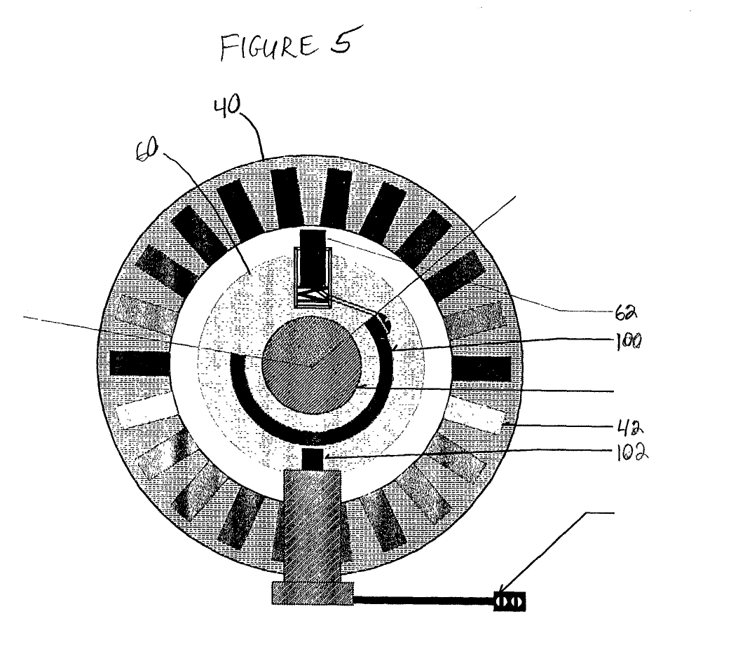

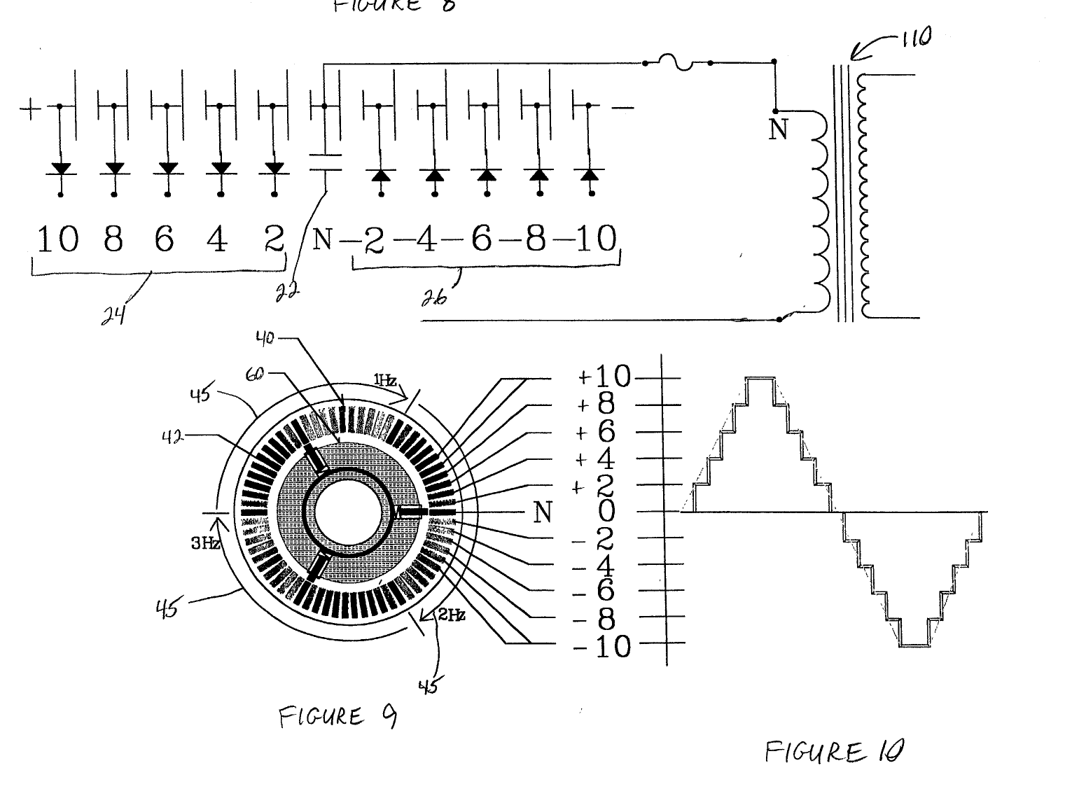

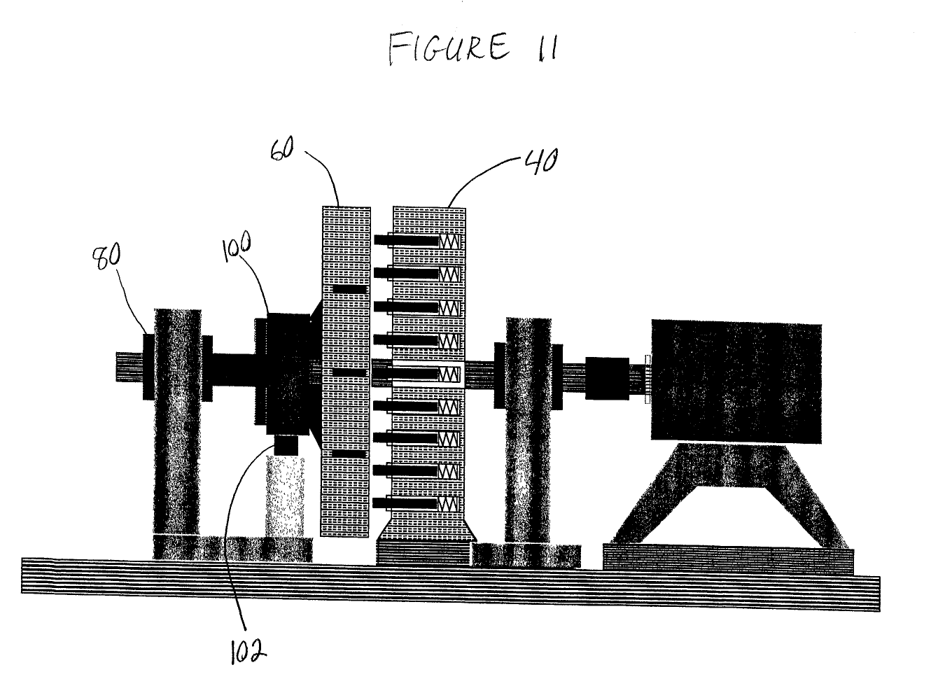

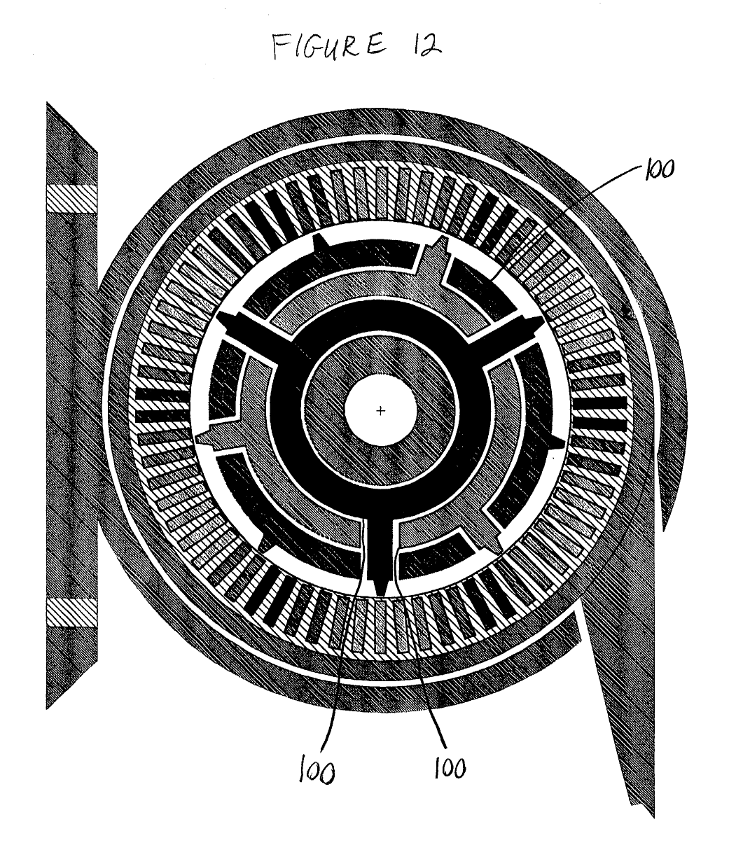

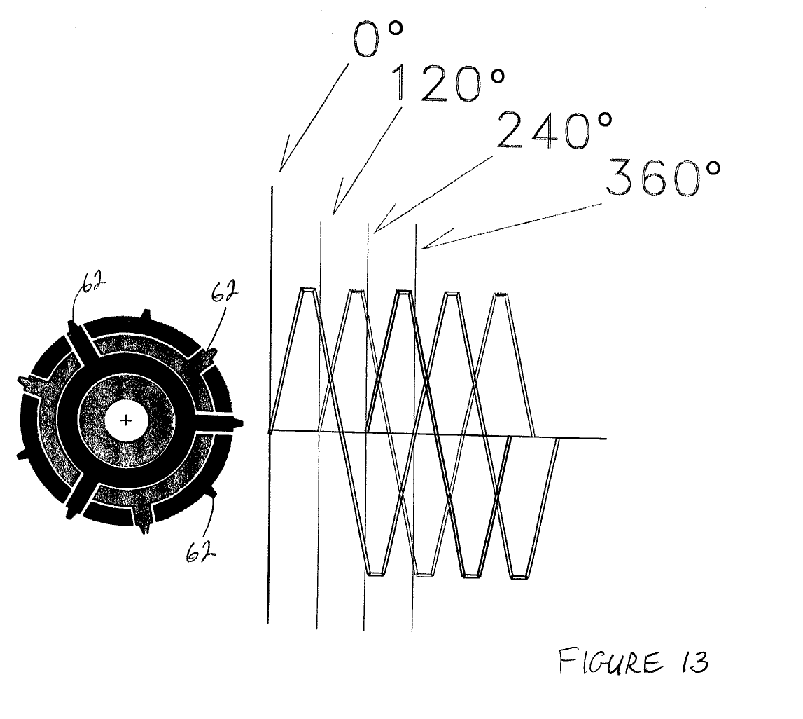

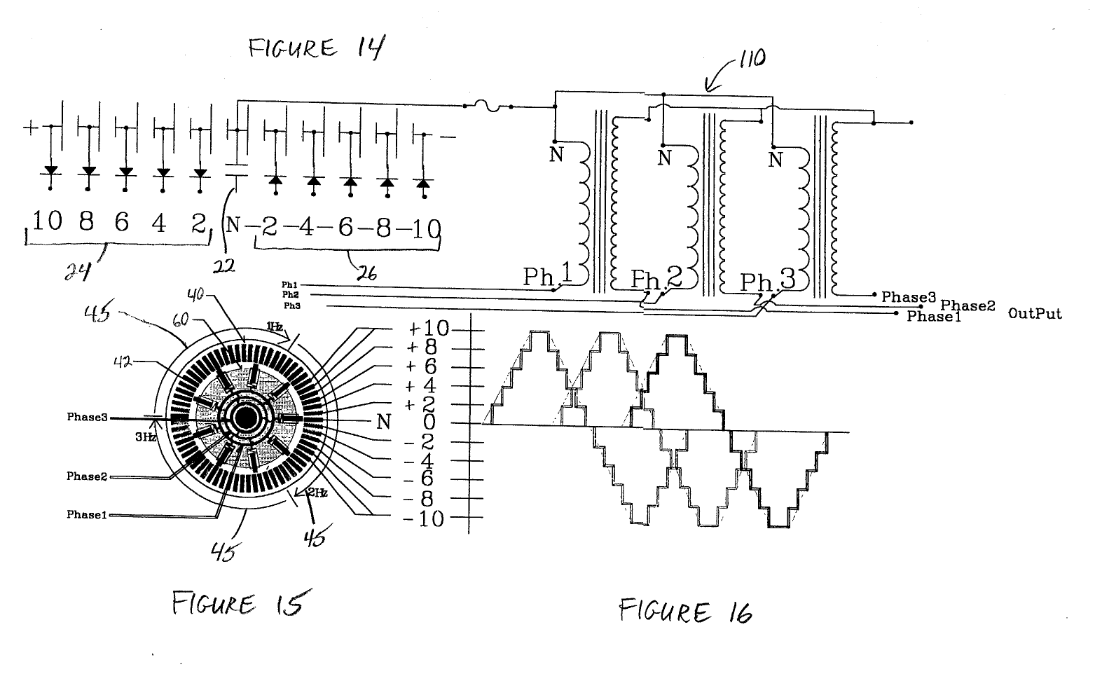

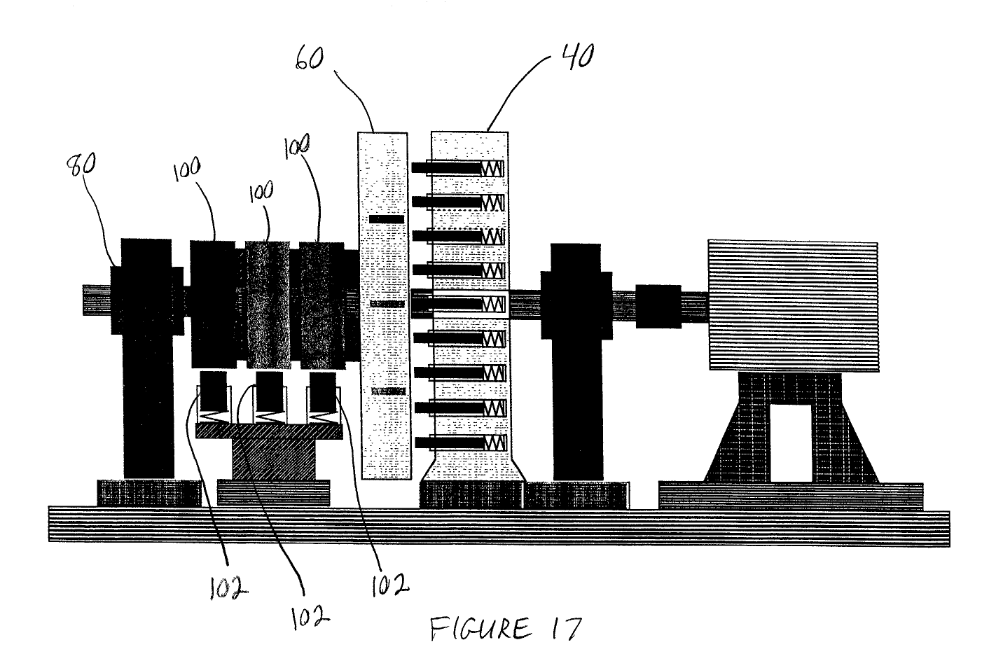

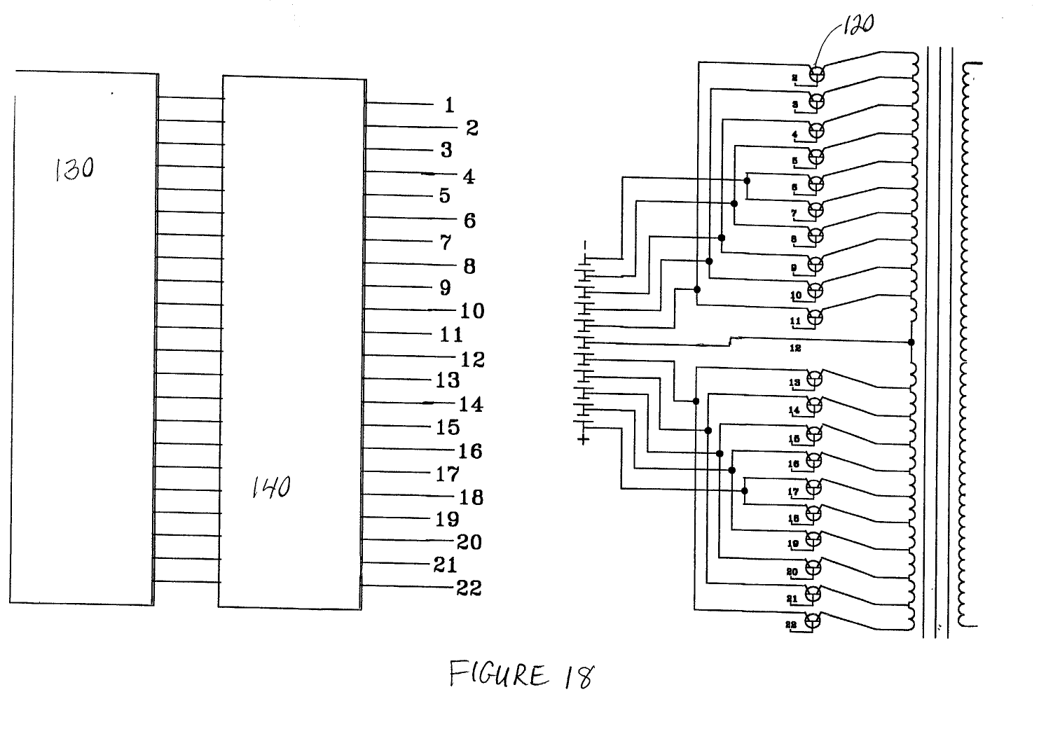

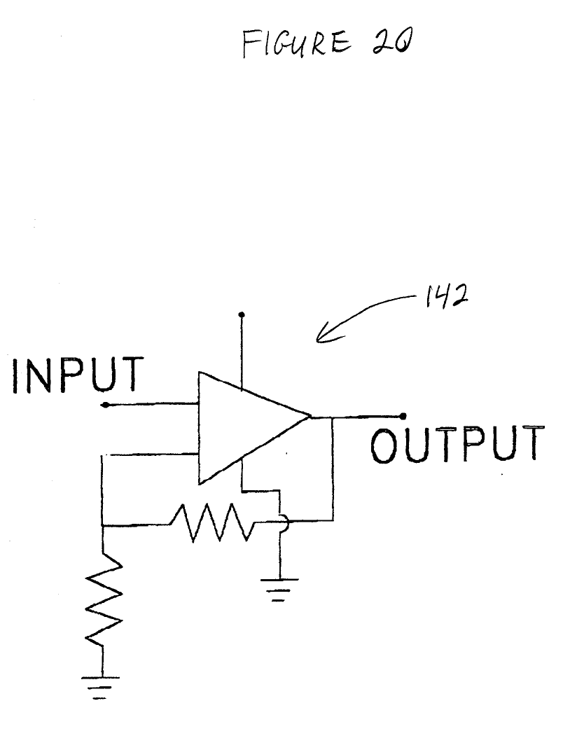

As shown in FIGS. 1-20, the present invention is directed towards a new and improved DC to AC inverter 10 comprising a battery 20 structured to provide a plurality of DC voltages and a switching system structured to separately receive each of the DC voltages and to separately and sequentially output each of the DC voltages to generate at least one substantially sine wave shaped output voltage waveform. The DC to AC inverter 10 of the present invention reduces the inefficiencies, power loss and heat dissipation associated with the prior art devices and extends the operating time of the backup or mobile power source and the useful life of the electronic equipment's components.

Although the DC to AC inverter 10 of the present invention may be used to produce any desired AC voltage, as well as single phase and multiple phase AC voltages, the following detailed description of the preferred embodiment will focus on producing a single phase 120 volts AC at a frequency of 60 Hertz, the regular line AC voltage available in the United States and many of countries. However, it should be appreciated that the DC to AC inverter 10 may be used to produce any combination of AC voltage and frequency.

The battery 20 may be of any type capable of providing more than one DC voltage. In the preferred embodiment, the battery 20 comprises a plurality of cells, each cell including a rechargeable chemical solution having the amperage necessary to power the desired electronic device. A common battery of this type is a lead-acid battery.

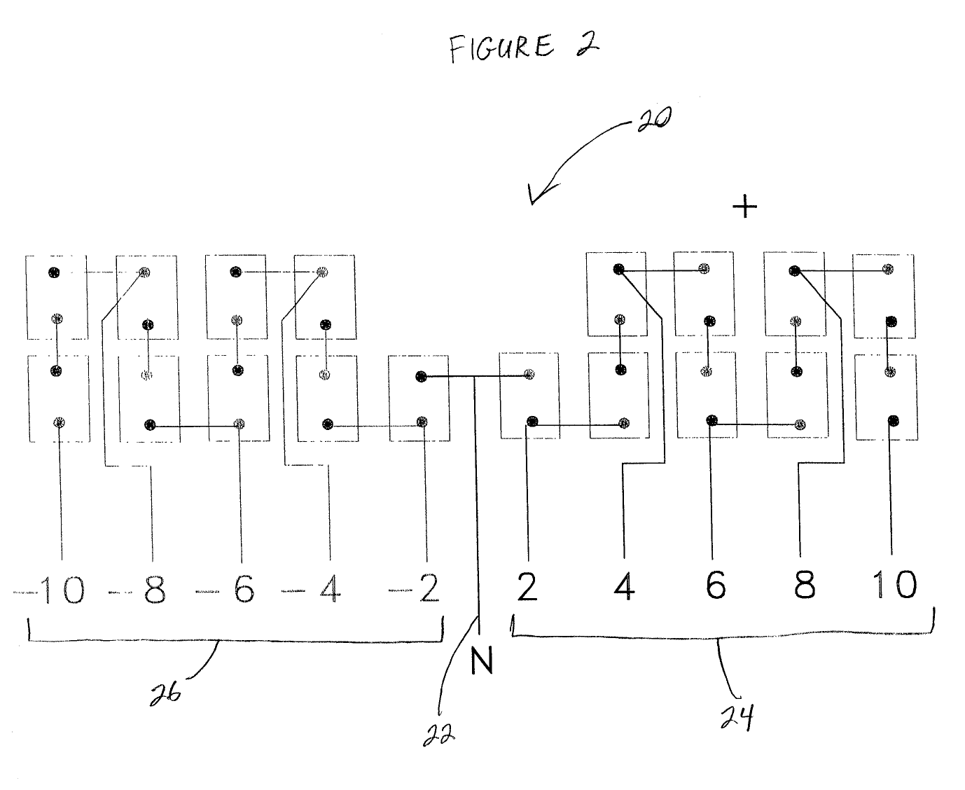

As shown in FIG. 2, the battery 20 of a preferred embodiment includes eighteen two volt rechargeable cells tied together in such a manner to produce voltages of between 0 and positive and negative 10 volts DC. It should, however, be appreciated that the number of cells and the voltage of each cell may vary to produce any desired AC voltage.

The battery 20 of the preferred embodiment includes eleven output terminals, each corresponding to a separate one of the DC voltages between 0 and positive and negative 10 volts. One of the output terminals 22 is electrically interconnected to ground. Five of the output terminals 24 are electrically interconnected to the positive terminal of alternate cells of the serially connected positive voltage cells to produce positive 2 volts, positive 4 volts, positive 6 volts, positive 8 volts and positive 10 volts. The remaining five output terminals 26 are electrically interconnected to the negative terminal of alternate cells of the serially connected negative voltage cells to produce negative 2 volts, negative 4 volts, negative 6 volts, negative 8 volts and negative 10 volts.

It should be appreciated that a greater or lesser number of output terminals could, alternatively, be used to produce a greater or lesser number of positive and negative DC voltages. As discussed further below, the voltages at the output terminals 22, 24, 26 are used to construct the sine wave defining AC voltages. The quality and efficiency of the sine wave produced is a function of the number of output terminals used and positive and negative voltages produced thereat. However, as the number of cells, output terminals and DC voltages used to construct the AC voltage sine wave increase, a point is reached at which the quality and efficiency of the sine wave do not improve appreciably as more cells, output terminals and DC voltages continue to be added. It should further be appreciated that any power source capable of providing multiple voltages could, alternatively, be used.

The switching system may be comprised of any embodiment, mechanical, electrical or other, capable of separately receiving each of the DC voltages and separately and sequentially outputting each of the DC voltages to generate the desired number of phases of substantially sine wave shaped output voltage waveforms. In a first preferred embodiment, the switching system comprises a mechanical rotation system having a stator 40, a rotor 60 and a motor 80.

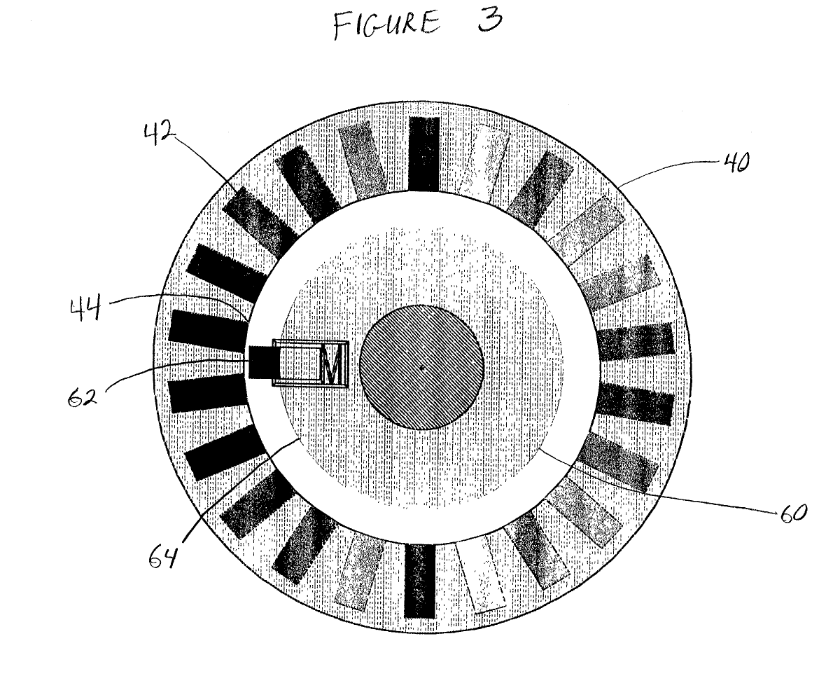

Referring now to FIGS. 3-7, the stator 40 includes a plurality of spaced-apart, conductive contacts 42 on its inner surface 44. The stator is preferably constructed of any type of non-conductive element. The contacts 42 are constructed of copper but may, alternatively, be constructed of any other suitable conductive material. Each contact 42 is electrically interconnected to one of the output terminals 22, 24, 26 of the battery 20.

The contacts 42 are arranged so that, as the inner surface 44 of said stator 40 is circumvented in a single direction, the DC voltage of successive contacts increase in steps from 0 volts to the uppermost DC voltage, positive 10 volts, and then decrease in steps to the lowermost voltage, negative 10 volts, and then increase in steps back to 0 volts. In the preferred embodiment, where eleven output terminals corresponding to eleven different DC voltages are utilized, twenty-two contacts 42 are used to create a complete sine wave.

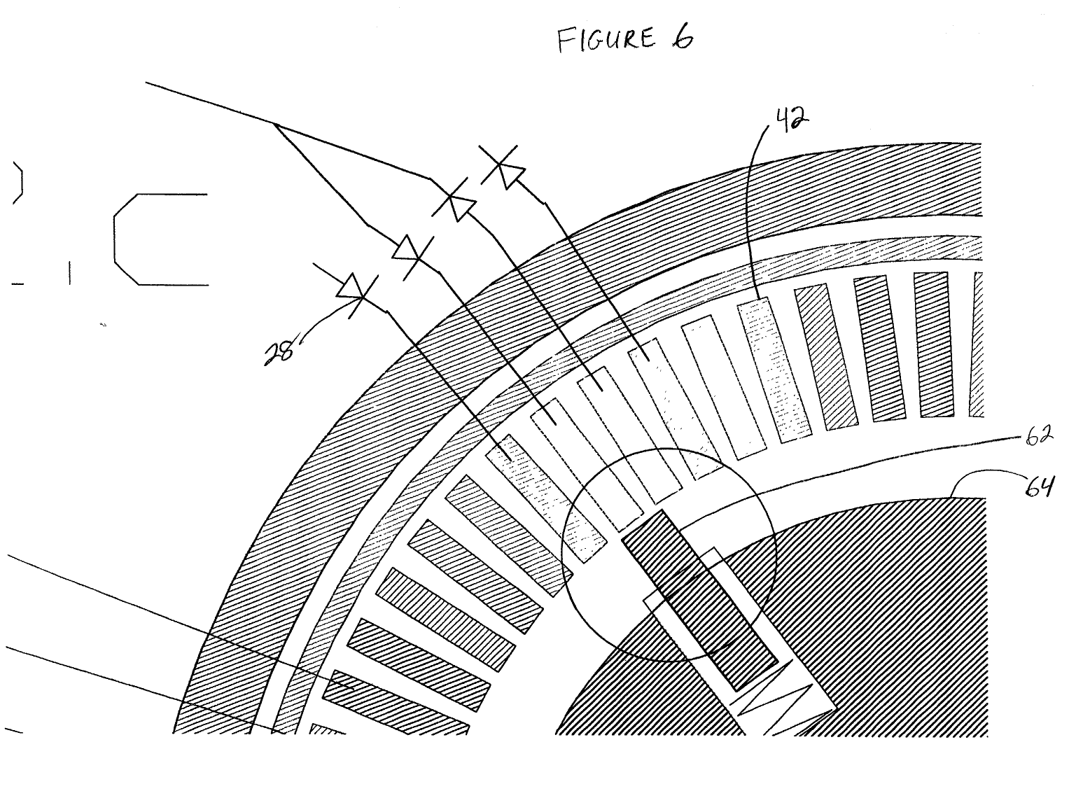

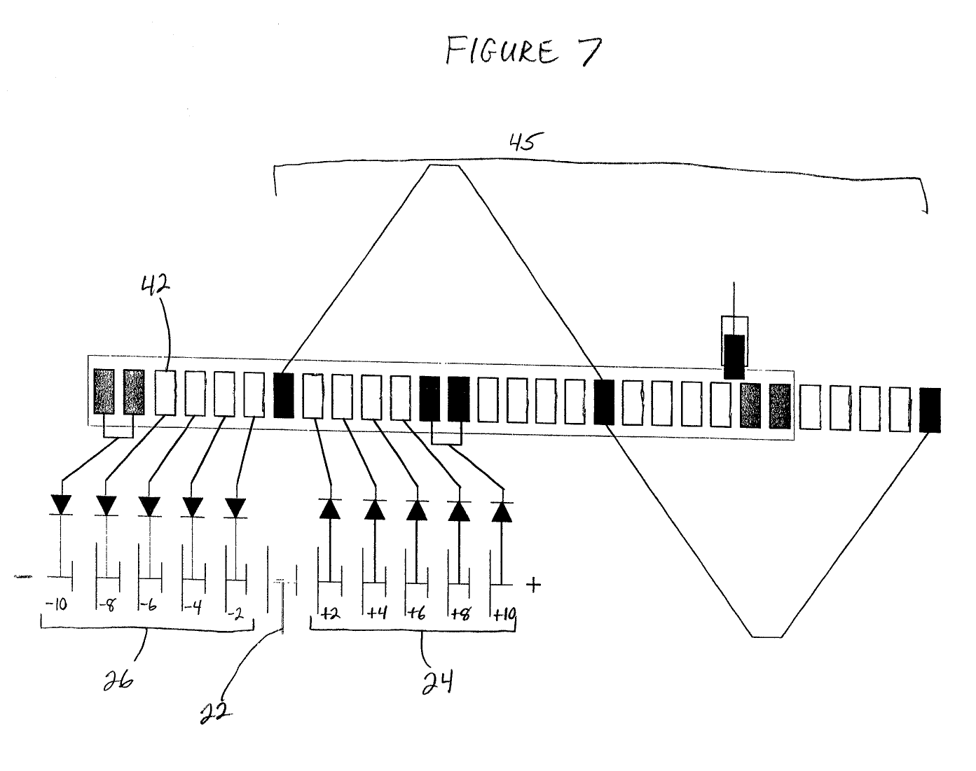

Referring now to FIG. 7, the DC voltages of the twenty-two contacts 42 are arranged to increase in steps, as the inner surface 44 of said stator 40 is circumvented in a single direction, from 0 volts to positive 2 volts, positive 4 volts, positive 6 volts, positive 8 volts and positive 10 volts (the uppermost DC voltage). The next contact 42 is again at positive 10 volts (the uppermost voltage) and the DC voltage of succeeding contacts 42 decrease in steps to positive 8 volts, positive 6 volts, positive 4 volts, positive 2 volts and 0 volts. The next contact 42 is again at 0 volts and the DC voltage of succeeding contacts 42 decrease in steps to negative 2 volts, negative 4 volts, negative 6 volts, negative 8 volts and negative 10 volts (the lowermost DC voltage). The next contact 42 is again at negative 10 volts (the lowermost voltage) and the DC voltage of succeeding contacts 42 increase in steps to negative 8 volts, negative 6 volts, negative 4 volts, negative 2 volts and back to 0 volts.

The rotor 60 is positioned within the stator 40 and structured to revolve within the stator 40. The rotor 60 includes at least one conductive brush 62 extending out from its outer surface 64. The brushes 62 may be of the type commonly used in motors or any other type suitable for this purpose. In the preferred embodiment in which sixty-six contacts are utilized (twenty-two to produce a complete sine wave), three brushes 62 may be arranged spaced apart 120 degrees on the rotor 60, so that, at any given time, each brush 62 electrically engages contacts 42 having the same DC voltage.

As the rotor 60 revolves within the stator 40, the brushes 62 electrically engage each contact 42 during one revolution of the rotor 62, causing the brushes 62 to pick up each contact's DC voltage as the brush 62 electrically engages each contact 42. As the rotor 60 revolves within the stator 40 and the brushes 62 electrically engage the twenty-two contacts 42 during each segment 45, the DC voltage present at the brushes 62 cycles from 0 volts (neutral) to positive 2 volts, positive 4 volts, positive 6 volts, positive 8 volts, positive 10 volts (the uppermost DC voltage), positive 10 volts, positive 8 volts, positive 6 volts, positive 4 volts, positive 2 volts, 0 volts, 0 volts, negative 2 volts, negative 4 volts, negative 6 volts, negative 8 volts, negative 10 volts (the lowermost DC voltage), negative 10 volts, negative 8 volts, negative 6 volts, negative 4 volts, negative 2 volts and back to 0 volts.

As described above, the contacts 42 are disposed so that each uppermost DC voltage, lowermost DC voltage and neutral are applied to adjacent contacts 42. However, it should be appreciated that these voltages may, alternatively, not be applied to adjacent contacts 42.

In this mechanical rotation embodiment, each of the battery 20 output terminals 22, 24, 26 is electrically interconnected to a diode 28. The diode 28 is structured to prevent a short circuit by isolating the higher voltage point from the lower voltage point during any time when the brush on the rotor 60 is in contact with two adjacent contacts on the stator 40. Any type of diode 28 suitable for this purpose and capable of handling the necessary current limits may be utilized.

Referring now to FIG. 7, it can be seen that the progression of voltages picked up by the brushes 62 during one cycle creates a sine wave of voltages approximating an AC voltage. Comparing the sine wave of FIG. 7 with the sine wave of FIG. 1, it can be further seen that the amount of wasted energy associated with the sine wave generated by the DC to AC inverter 10 of the present invention is much less than with the sine wave generated by conventional electronic inverter circuitry.

In the preferred embodiment, where eleven output terminals corresponding to eleven different DC voltages are utilized, the stator 40 may include one or more segments 45 of twenty-two contacts 42. Each such segment 45 will generate a complete sine wave. Thus, if the stator 40 includes forty-four contacts 42, two complete sine waves will be generated in a single revolution.

The rotational speed of the rotor 60 within the stator 40 is a function of the number of segments 45 within the stator 40 and the desired frequency. The relationship between the rotational speed of the rotor 60, the number of segments 45 within the stator 40 and the frequency is defined by the equation:

$$\frac{RPM \times N}{60} = F$$

where, RPM=revolutions per minute of the rotor 60,

N=number of segments 45 within the stator 40, and

F=the desired frequency.

For instance, if a frequency of 60 hertz is desired and only one segment 45 is included within the stator 40, the rotor 60 must revolve at 3,600 revolutions per minute. If the stator 40 includes two segments 45, the rotor 60 must revolve at 1,800 revolutions per minute to produce the same 60 hertz frequency.

The rotor 60 is driven by a motor 80. The motor may be powered by the battery 20 or by a separate battery (not shown).

In the first preferred embodiment, the brushes 62 are electrically interconnected to a slip ring 100, structured to rotate with the rotor 60. The slip ring 100 may be either fully constructed of a conductive material or only have its outer surface constructed of a conductive material. A conductive output brush 102 is positioned adjacent the slip ring 100, in electrical communication therewith, and is structured to pick up the slip ring 100 voltage. It should be appreciated that any other suitable conductive pickup element may be used in place of the output brush 102.

As the rotor 60 rotates and the brushes 62 sequentially pick up the DC voltages from the contacts 42, in increasing and then decreasing steps, a substantially sine wave shaped voltage waveform is produced at the brushes 62 and passed from the brushes 62 to the slip ring 100 and from the slip ring 100 to the output brush 102. The resultant AC voltage may then be electrically interconnected to the desired electronic device.

Although the above described first preferred embodiment is structured for rotation of the rotor 60 within the stator 40, with the conductive contacts 42 on the inner surface 44 of the stator 40 and the brushes 62 on the outer surface 64 of the rotor 60, it should be appreciated that various other configurations of stator 40, rotor 60, contacts 42 and brushes 62 can, alternatively, be employed. For instance, the brushes 62 could be disposed on the inner surface 44 of the stator 40 and the contacts 42 on the rotor 60. Alternatively, the rotor 60 could be disposed outside of the stator 40, with the contacts 42 or brushes 62 on the inner surface 44 or outer surface of the stator 40. In sum, any desired configuration, which enables the DC voltages to be sequentially communicated from the stator 40 to the pickup elements on the rotor 60, could be employed.

Referring now to FIGS. 18-20, in a second preferred embodiment, the switching system comprises an electronic circuit having a plurality of transistors 120 and control circuitry structured to sequentially trigger each transistor 120. Using the battery 20 with the eleven output terminals described above, twenty-two transistors 120 are used to create a complete sine wave. Each transistor 120 receives one of the battery 20 DC voltages as its collector input so that each DC voltage, including neutral, is applied to two of the twenty-two transistors 120 used to generate the complete sine wave. The transistor 120 may be of any type suitable for this use. In this second preferred embodiment, a transistor 120 commercially known as a 2N3055 is used.

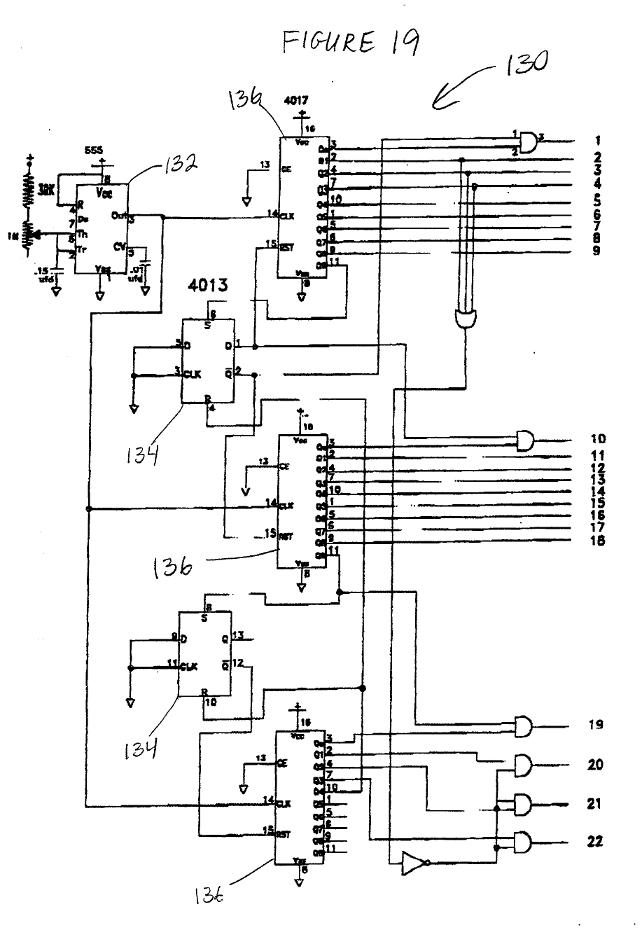

The control circuitry of this second preferred embodiment comprises a signal generator portion 130 and an amplifier portion 140. Referring now to FIG. 19, the signal generator portion 130 comprises control oscillators 132, counters 134 and dividers 136. The oscillators 132 provide the clock input signal to the dividers 136, and the counters 134 provide a trigger signal to the dividers 136. The oscillators 132 of the second preferred embodiment are of the type commercially known as a 555 and the counters are of the type commercially known as a 4013. However, it should be appreciated that any other suitable oscillators 132 and counters 134 may, alternatively, be used.

The divider 136 of the second preferred embodiment is of the type commercially known as a 4017 and includes 9 outputs, each of which is electrically interconnected to one amplifier 142. Using the twenty-two transistors 120 to create a complete sine wave, three dividers 136 of the 4017 type are necessary to produce the twenty-two trigger signals. It should be appreciated that any other suitable divider may, alternatively, be used.

When triggered, each divider 136 output emits a low voltage pulse. Each pulse is amplified to approximate one of the battery DC voltages. With twenty-two divider 136 outputs, twenty-two amplifiers 142 are used. Any suitable amplifier 142 may be used, such as those commercially known as an LH0132.

The amplifier 142 outputs are electrically interconnected to the base of a transistor 120 having a DC voltage at its collector approximately equal to the DC voltage of the amplifier 142 output. The transistors 120 are structured so that the emitter voltage equals the lesser of the collector voltage or base voltage. Thus, when the base is at 0 volts, the emitter is also at 0 volts and when the base receives the voltage pulse from the amplifier 142, which, in the second preferred embodiment, will approximate the voltage at the collector, the emitter voltage will be the same as the DC voltage from the battery 20 at the collector.

The switching system of this second preferred embodiment generates the same substantially sine wave shaped voltage waveform as produced by the first preferred embodiment described above. The sequence of pulses from the dividers 136 will cause the transistors 120 to emit a sequence of increasing and decreasing DC voltages, thereby creating a substantially sine wave shaped voltage waveform. The resultant AC voltage may then be electrically interconnected to the desired electronic device.

The substantially sine wave shaped voltage waveform output from the first and second preferred embodiments may be fed through a transformer 110 to step up the voltage to the desired AC voltage and to isolate the battery 20 from the resultant output voltage. The transformer 110 may also be used to produce a smoother or cleaner sine wave.

As mentioned above, the DC to AC inverter 10 of the present invention may also be used to produce a three phase AC voltage. Using the mechanical rotation system of the first preferred embodiment, the three phase voltage may be produced by providing additional pickup brushes 62 on the rotor 60. With the sixty-six contacts 42 described above (three sets of the twenty-two contacts 42 necessary to produce a complete sine wave), the brushes 62 associated with each phase are each spaced apart by 120 degrees. Separate slip rings 100 are used for each phase and each such slip ring 100 is electrically interconnected to the brushes 62 associated with its phase. A conductive output brush 102 is positioned adjacent each slip ring 100, in electrical communication therewith, and is structured to pick up the slip ring 100 voltage.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

What is claimed is:

1. A differential DC voltage inverter comprising:
a power source having a plurality of DC voltages, said DC voltages ranging from an upper positive voltage to a lower negative voltage of the same relative value as said upper positive voltage and including a neutral; and
a switching system structured to separately receive each of said DC voltages and to separately and sequentially output each of said DC voltages to generate at least one substantially sine wave shaped output voltage waveform.

2. A differential DC voltage inverter as recited in claim 1 wherein said switching system comprises:
a stator having a plurality of spaced-apart, conductive members, each of said conductive members being electrically interconnected to one of said DC voltages;
a rotor having at least one conductive pickup element, said rotor being structured and disposed to revolve so that said pickup elements sequentially come into electrical communication with each of said conductive members during one revolution of said rotor, causing each of said pickup elements to sequentially pick up said DC voltage of each of said conductive members as said pickup elements come into electrical communication with said conductive members;
said conductive members being arranged so that said DC voltages of successive conductive members as said stator is circumvented in a single direction increase in steps from said lower negative voltage to each of said DC voltages between said lower negative voltage and said upper positive voltage and then decrease in steps from said upper positive voltage to each of said DC voltages between said upper positive voltage and said lower negative voltage; and
means for rotating said rotor at a desired frequency so that a substantially sine wave shaped waveform is produced.

3. A differential DC voltage inverter as recited in claim 2 wherein said conductive members are electrical brushes.

4. A differential DC voltage inverter as recited in claim 2 wherein said conductive pickup elements are electrical brushes.

5. A differential DC voltage inverter as recited in claim 2 further comprising at least one slip ring structured to rotate with said rotor and at least one conductive output element in electrical communication with each of said slip rings, each of said slip rings being electrically interconnected to one said pickup elements.

6. A differential DC voltage inverter as recited in claim 5 wherein said conductive output elements are electrical brushes.

7. A differential DC voltage inverter as recited in claim 2 wherein said conductive members are disposed on an inner surface of said stator and said rotor is structured and disposed to revolve within said stator.

8. A differential DC voltage inverter as recited in claim 2 wherein said conductive members are disposed on an outer surface of said stator and said rotor is positioned adjacent said stator.

9. A differential DC voltage inverter as recited in claim 1 wherein said switching system comprises:
a plurality of transistors, each of said transistors being electrically interconnected to one of said DC voltages; and
a control circuit structured to sequentially trigger each of said transistors so that said DC voltages of successively triggered transistors increase in steps from said lower negative voltage to each of said DC voltages between said lower negative voltage and said upper positive voltage and then decrease in steps from said upper positive voltage to each of said DC voltages between said upper positive voltage and said lower negative voltage to produce said substantially sine wave shaped output voltage waveforms.

10. A differential DC voltage inverter as recited in claim 2, wherein a single cycle of said sine wave shaped waveform is generated by outputting said DC voltages in the following sequence:
a. said neutral;
b. each of said DC voltages between said neutral and said upper positive voltage, in increasing voltage order;
c. said upper positive voltage;
d. each of said DC voltages between said upper positive voltage and said neutral, in decreasing voltage order;
e. said neutral;
f. each of said DC voltages between said neutral and said lower negative voltage, in decreasing voltage order;
g. said lower negative voltage; and
h. each of said DC voltages between said lower negative voltage and said neutral, in increasing voltage order.

11. A differential DC voltage inverter as recited in claim 2, wherein a single cycle of said sine wave shaped waveform is generated by applying said DC voltages in the following sequence:
a. said neutral;
b. each of said DC voltages between said neutral and said upper positive voltage, in increasing voltage order;
c. said upper positive voltage;
d. said upper positive voltage;
e. each of said DC voltages between said upper positive voltage and said neutral, in decreasing voltage order;
f. said neutral;
g. each of said DC voltages between said neutral and said lower negative voltage, in decreasing voltage order;
h. said lower negative voltage;
i. said lower negative voltage; and
j. each of said DC voltages between said lower negative voltage and said neutral, in increasing voltage order.

12. A differential DC voltage inverter as recited in claim 2, wherein a single cycle of said sine wave shaped waveform is generated by applying said DC voltages in the following sequence:
a. said neutral;
b. each of said DC voltages between said neutral and said upper positive voltage, in increasing voltage order;
c. said upper positive voltage;
d. said upper positive voltage;
e. each of said DC voltages between said upper positive voltage and said neutral, in decreasing voltage order;
f. said neutral;
g. said neutral;
h. each of said DC voltages between said neutral and said lower negative voltage, in decreasing voltage order;
i. said lower negative voltage;
j. said lower negative voltage;
k. each of said DC voltages between said lower negative voltage and said neutral, in increasing voltage order; and
l. said neutral.

13. A differential DC voltage inverter as recited in claim 1 wherein said power source is a battery.

14. A differential DC voltage inverter as recited in claim 1 further comprising at least one transformer electrically interconnected to said output voltages.

15. A differential DC voltage inverter as recited in claim 1 wherein said switching system generates one substantially sine wave shaped output voltage defining a single phase output voltage.

16. A differential DC voltage inverter as recited in claim 1 wherein said switching system generates three substantially sine wave shaped output voltages defining a three phase output voltage.

17. A differential DC voltage inverter as recited in claim 2 wherein said means for rotating said rotor is a motor.

18. A differential DC voltage inverter comprising:
a power source having a plurality of DC voltages, said DC voltages ranging from an upper positive voltage to a lower negative voltage of the same relative value as said upper positive voltage and including a neutral;
a stator having a plurality of spaced-apart, conductive members, each of said conductive members being electrically interconnected to one of said DC voltages;
a rotor having at least one conductive pickup element, said rotor being structured and disposed to revolve so that said pickup elements sequentially come into electrical communication with each of said conductive members during one revolution of said rotor, causing each of said pickup elements to sequentially pick up said DC voltage of each of said conductive members as said pickup elements come into electrical communication with said conductive members;
said conductive members being arranged so that said DC voltages of successive conductive members as said stator is circumvented in a single direction increase in steps from said lower negative voltage to each of said DC voltages between said lower negative voltage and said upper positive voltage and then decrease in steps from said upper positive voltage to each of said DC voltages between said upper positive voltage and said lower negative voltage to generate at least one substantially sine wave shaped output voltage waveform;
at least one slip ring structured to rotate with said rotor and at least one conductive output element in electrical communication with each of said slip rings, each of said slip rings being electrically interconnected to one said pickup elements; and
means for rotating said rotor at a desired frequency so that at least one substantially sine wave shaped waveform is produced at said output elements.

19. A differential DC voltage inverter as recited in claim 18 wherein said conductive members are electrical brushes.

20. A differential DC voltage inverter as recited in claim 18 wherein said conductive pickup elements are electrical brushes.

21. A differential DC voltage inverter as recited in claim 18 wherein said conductive output elements are electrical brushes.

22. A differential DC voltage inverter as recited in claim 18 wherein said conductive members are disposed on an inner surface of said stator and said rotor is structured and disposed to revolve within said stator.

23. A differential DC voltage inverter as recited in claim 18 wherein said conductive members are disposed on an outer surface of said stator and said rotor is positioned adjacent said stator.

24. A differential DC voltage inverter as recited in claim 18, wherein a single cycle of said sine wave shaped waveform is generated by outputting said DC voltages in the following sequence:
a. said neutral;
b. each of said DC voltages between said neutral and said upper positive voltage, in increasing voltage order;
c. said upper positive voltage;
d. each of said DC voltages between said upper positive voltage and said neutral, in decreasing voltage order;
e. said neutral;
f. each of said DC voltages between said neutral and said lower negative voltage, in decreasing voltage order;
g. said lower negative voltage; and
h. each of said DC voltages between said lower negative voltage and said neutral, in increasing voltage order.

25. A differential DC voltage inverter as recited in claims 18, wherein a single cycle of said sine wave shaped waveform is generated by applying said DC voltages in the following sequence:
a. said neutral;
b. each of said DC voltages between said neutral and said upper positive voltage, in increasing voltage order;
c. said upper positive voltage;
d. said upper positive voltage;
e. each of said DC voltages between said upper positive voltage and said neutral, in decreasing voltage order;
f. said neutral;
g. each of said DC voltages between said neutral and said lower negative voltage, in decreasing voltage order;
h. said lower negative voltage;
i. said lower negative voltage; and
j. each of said DC voltages between said lower negative voltage and said neutral, in increasing voltage order.

26. A differential DC voltage inverter as recited in claims 2 and 9, wherein a single cycle of said sine wave shaped waveform is generated by applying said DC voltages in the following sequence:
a. said neutral;
b. each of said DC voltages between said neutral and said upper positive voltage, in increasing voltage order;
c. said upper positive voltage;
d. said upper positive voltage;
e. each of said DC voltages between said upper positive voltage and said neutral, in decreasing voltage order;
f. said neutral;
g. said neutral;
h. each of said DC voltages between said neutral and said lower negative voltage, in decreasing voltage order;
i. said lower negative voltage;
j. said lower negative voltage;
k. each of said DC voltages between said lower negative voltage and said neutral, in increasing voltage order; and
L. said neutral.

27. A differential DC voltage inverter as recited in claim 18 wherein said power source is a battery.

28. A differential DC voltage inverter as recited in claim 18 further comprising at least one transformer electrically interconnected to said output voltages.

29. A differential DC voltage inverter as recited in claim 18 wherein one substantially sine wave shaped output voltage, defining a single phase output voltage, is produced at said output elements.

30. A differential DC voltage inverter as recited in claim 18 wherein said three substantially sine wave shaped output voltages, defining a three phase output voltage, is produced at said output elements.

31. A differential DC voltage inverter as recited in claim 18 wherein said means for rotating said rotor is a motor.
